(19) United States
(12) Patent Application Publication
(10) Pub. No.: US 2026/0105593 A1
(43) Pub. Date: Apr. 16, 2026

(54) INFORMATION PROCESSING APPARATUS, INFORMATION PROCESSING METHOD, AND LEARNING METHOD

(71) Applicant: Lasertec Corporation, Yokohama (JP)

(72) Inventor: Mizuki KOBAYASHI, Yokohama-shi (JP)

(21) Appl. No.: 19/355,781

(22) Filed: Oct. 10, 2025

(30) Foreign Application Priority Data
Oct. 11, 2024 (JP) 2024-179161
Sep. 22, 2025 (JP) 2025-156820

(51) Int. Cl. G06T 7/00; G06V 10/75; G06V 10/764; G06V 10/774; G06V 10/776

(52) U.S. Cl. CPC G06T 7/001; G06V 10/759; G06V 10/764; G06V 10/774; G06V 10/776; G06T 2207/20081

(57) ABSTRACT

The information processing apparatus according to the present embodiment includes: a learning unit configured to train a model; a captured image acquisition unit configured to acquire a captured image; a reference image generation unit configured to generate a reference image; and an evaluation unit configured to evaluate the object based on a comparison between the reference image and the captured image, the learning unit includes a residual calculation unit configured to calculate a residual by comparing a generated image output from the model in a training course with a training image including the captured image, and a determination unit configured to determine that training of the model is completed when the residual satisfies a predetermined condition, and the residual calculation unit calculates a residual based on the differential image.

### INCORPORATION BY REFERENCE

This application is based upon and claims the benefit of priority from Japanese patent application No. 2024-179161, filed on Oct. 11, 2024, and Japanese patent application No. 2025-156820, filed on Sep. 22, 2025, the disclosure of which is incorporated herein in its entirety by reference for all purposes.

### BACKGROUND

The present disclosure relates to an information processing apparatus, an inspection apparatus, an information processing method, an inspection method, and a learning method.

International Patent Publication No. WO 2019/216303 discloses an inspection method of comparing a captured image of a photomask manufactured based on design data with a reference image generated from the design data, thereby inspecting the photomask. The inspection method disclosed in International Patent Publication No. WO 2019/216303 generates the reference image from the design data using a machine learning model.

The machine learning model disclosed in International Patent Publication No. WO 2019/216303 generally determines that training of the model is completed when a difference (residual or loss) between an output image and a captured image due to the model in a training course falls below a predetermined threshold.

However, the inventors have found that, depending on properties of an object being captured, noise tends to be generated in some regions of the captured image. Here, since the residual may include a residual based on lack of training of the model and a residual based on the noise in the captured image, the residual is more likely to occur in a region in which noise tends to be generated than a region in which noise does not tend to be generated. When the training completion of the model is managed without taking this into consideration, there is a problem that the accuracy in generating the output image by the trained model is insufficient.

The present disclosure has been made in consideration of such a problem, and is to provide an information processing apparatus, an inspection apparatus, an information processing method, an inspection method, and a learning method that can improve the ability to deal with regions in which noise tends to be generated.

### SUMMARY

An information processing apparatus according to an aspect of the present embodiment includes: a learning unit configured to train a model; a captured image acquisition unit configured to acquire a captured image obtained by capturing an image of an object; a reference image generation unit configured to generate a reference image based on design data of the object and the model; and an evaluation unit configured to evaluate the object based on a comparison between the reference image and the captured image, the learning unit including: a residual calculation unit configured to calculate a residual by comparing a generated image output from the model in a training course with a training image including the captured image; and a determination unit configured to determine that training of the model is completed when the residual satisfies a predetermined condition, the residual calculation unit being configured to: calculate the residual based on a differential image obtained by a difference between information regarding each pixel in the generated image and information regarding each pixel in the training image; calculate a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and calculate the residual of the differential image by performing arithmetic processing on the corrected evaluation value.

In the information processing apparatus, the residual calculation unit may perform a larger weighting on the evaluation value of the second pixel than on the evaluation value of the first pixel.

In the information processing apparatus, the residual calculation unit may calculate the residual of the differential image by performing arithmetic processing on at least one of an average value of the corrected evaluation values of the plurality of pixels and a maximum value of the corrected evaluation values of the plurality of pixels.

In the information processing apparatus, the residual calculation unit may be configured to: acquire a statistical value indicating a degree of variation in information regarding a pixel among a plurality of captured images for a plurality of pixels of the captured images, based on a comparison of the plurality of captured images for a substantially same region of the object; and calculate the weighting for the evaluation value of the differential image based on the acquired statistical value.

An inspection apparatus according to an aspect of the present embodiment includes: an image capturing apparatus configured to capture an image of the object; and the information processing apparatus described above.

An information processing method according to an aspect of the present embodiment includes steps of: training a model; acquiring a captured image obtained by capturing an image of an object; generating a reference image based on design data of the object and the model; and evaluating the object based on a comparison between the reference image and the captured image, the step of training the model including steps of: calculating a residual by comparing a generated image output from the model in a training course with a training image including the captured image; and determining that training of the model is completed when the residual satisfies a predetermined condition, the step of calculating the residual including: calculating the residual based on a differential image obtained by a difference between information regarding each pixel in the generated image and information regarding each pixel in the training image; calculating a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and calculating the residual of the differential image by performing arithmetic processing on the corrected evaluation value.

In the information processing method, the step of calculating the residual may include performing a larger weighting on the evaluation value of the second pixel than on the evaluation value of the first pixel.

In the information processing method, the step of calculating the residual may include calculating the residual of the differential image by performing arithmetic processing on at least one of an average value of the corrected evaluation values of the plurality of pixels and a maximum value of the corrected evaluation values of the plurality of pixels.

In the information processing method, the step of calculating the residual may include: acquiring a statistical value indicating a degree of variation in information regarding a pixel among a plurality of captured images for a plurality of pixels of the captured images, based on a comparison of the plurality of captured images for a substantially same region of the object; and calculating the weighting for the evaluation value of the differential image based on the acquired statistical value.

An inspection method according to an aspect of the present embodiment includes steps of: capturing an image of an object; and performing information processing using the information processing method described above.

A learning method according to an aspect of the present embodiment includes steps of: calculating a residual by comparing a generated image output from a model in a training course with a training image including a captured image obtained by capturing an image of an object; and determining that training of the model is completed when the residual satisfies a predetermined condition, the step of calculating the residual including: calculating the residual based on a differential image obtained by a difference between information regarding each pixel in the generated image and information regarding each pixel in the training image; calculating a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and calculating the residual of the differential image by performing arithmetic processing on the corrected evaluation value.

In the learning method, the step of calculating the residual may include performing a larger weighting on the evaluation value of the second pixel than on the evaluation value of the first pixel.

In the learning method, the step of calculating the residual may include calculating the residual of the differential image by performing arithmetic processing on at least one of an average value of the corrected evaluation values of the plurality of pixels and a maximum value of the corrected evaluation values of the plurality of pixels.

In the learning method, the step of calculating the residual may include: acquiring a statistical value indicating a degree of variation in information regarding a pixel among a plurality of captured images for a plurality of pixels of the captured images, based on a comparison of the plurality of captured images for a substantially same region of the object, and calculating the weighting for the evaluation value of the differential image based on the acquired statistical value.

A learning method according to an aspect of the present embodiment includes steps of: calculating a residual by comparing a generated image output from a model in a training course with a training image including a captured image obtained by capturing an image of an object; determining that training of the model is completed when the residual satisfies a predetermined condition; and classifying a plurality of pixels in the captured image into either a first group of pixels or a second group of pixels, based on a comparison of a plurality of captured images for a substantially same region of the object, the second group of pixels are pixels having smaller variation in information regarding the pixels among the plurality of captured images with respect to the substantially same region of the object than the first group of pixels, and the step of calculating the residual includes: calculating the residual based on a differential image obtained by a difference between information regarding each pixel in the generated image and information regarding each pixel in the training image; calculating a corrected evaluation value, which is corrected by performing different weightings on an evaluation value of a first pixel corresponding to the first group of pixels in the differential image and an evaluation value of a second pixel corresponding to the second group of pixels in the differential image; and calculating the residual of the differential image by performing arithmetic processing on the corrected evaluation value.

A learning method according to an aspect of the present embodiment includes steps of: calculating a residual by comparing a generated image output from a model in a training course with a training image including a captured image obtained by capturing an image of an object; determining that training of the model is completed when the residual satisfies a predetermined condition; and classifying a plurality of pixels in the captured image into either a first group of pixels or a second group of pixels, based on a comparison of a plurality of captured images for a substantially same region of the object, the second group of pixels are pixels having smaller variation in information regarding the pixels among the plurality of captured images with respect to the substantially same region of the object than the first group of pixels, the step of calculating the residual includes calculating a first residual for a first pixel corresponding to the first group of pixel in the differential image and a second residual for a second pixel corresponding to the second group of pixels in the differential image, based on a differential image obtained by a difference between information regarding each pixel in the generated image and information regarding each pixel in the training image, and the step of determining that training of the model is completed when the residual satisfies a predetermined condition includes determining that the training of the model is completed when a second predetermined condition applied to the second residual is a stricter condition than a first predetermined condition applied to the first residual, the second residual satisfies the second predetermined condition, and the first residual satisfies the first predetermined condition.

A learning method according to an aspect of the present embodiment includes steps of: classifying a plurality of pixels in a captured image into either a first group of pixels or a second group of pixels, based on a comparison of a plurality of captured images for a substantially same region of an object; and using, as training data, the captured image of the object and an image based on design data of the object, and training a model that outputs, based on the design data, a reference image to be compared with the captured image, the second group of pixels are pixels having smaller variation in information regarding the pixels among the plurality of captured images with respect to the substantially same region of the object than the first group of pixels, and in the step of training the model, the training data includes the captured image including the first group of pixels and the captured image including the second group of pixels, and the number of captured images including the first group of pixels is larger than the number of captured images including the second group of pixels.

According to the present disclosure, it is possible to provide an information processing apparatus, an inspection apparatus, an information processing method, an inspection method, and a learning method that can improve the ability to deal with regions in which noise tends to be generated.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram illustrating an inspection apparatus according to a first embodiment;

FIG. 2 is a diagram illustrating an example during training of a rendering model in the information processing apparatus according to the first embodiment;

FIG. 3 is a diagram illustrating an example during inspection using the rendering model that is completely trained in the information processing apparatus according to the first embodiment;

FIG. 4 is a configuration diagram illustrating an image capturing apparatus according to the first embodiment;

FIG. 5 is a configuration diagram illustrating another image capturing apparatus according to the first embodiment;

FIG. 6 is a block diagram illustrating a configuration of the information processing apparatus according to the first embodiment;

FIG. 7 is a diagram illustrating residual calculation performed by a residual calculation unit in the information processing apparatus according to the first embodiment;

FIG. 8 is a plan view illustrating a generated image in the information processing apparatus according to the first embodiment;

FIG. 9 is a plan view illustrating a training image in the information processing apparatus according to the first embodiment;

FIG. 10 is a plan view illustrating a differential image in the information processing apparatus according to the first embodiment;

FIG. 11 is a graph illustrating a function used for weighting by the residual calculation unit in the information processing apparatus according to the first embodiment, where a horizontal axis represents luminance and a vertical axis represents a standard deviation as weighting;

FIG. 12 is a graph illustrating a distribution of evaluation values (differential values) before the weighting is performed in the information processing apparatus according to the first embodiment, where a horizontal axis represents sample pixel information (luminance) and a vertical axis represents an evaluation value (differential value);

FIG. 13 is a graph illustrating a distribution of evaluation values (differential values) after the weighting is performed in the information processing apparatus according to the first embodiment, where a horizontal axis represents sample pixel information (luminance) and a vertical axis represents a corrected evaluation value;

FIG. 14 is a graph illustrating a distribution of evaluation values (differential values) of pixels in a differential captured image obtained by a difference between captured images in the information processing apparatus according to the first embodiment, where a horizontal axis represents luminance of the pixels in the captured images and a vertical axis represents an evaluation value (differential value);

FIG. 15 is a flowchart illustrating an information processing method using the information processing apparatus according to the first embodiment;

FIG. 16 is a flowchart illustrating a learning method using a learning unit in the information processing apparatus according to the first embodiment;

FIG. 17 is a flowchart illustrating a residual calculation method performed by the residual calculation unit in the inspection apparatus according to the first embodiment;

FIG. 18 is a flowchart illustrating an inspection method according to the first embodiment;

FIG. 19 is a block diagram illustrating a configuration of an information processing apparatus according to a modified example of the first embodiment;

FIG. 20 is a graph illustrating a distribution of evaluation values (differential values) of pixels in a differential captured image obtained by a difference between captured images in an information processing apparatus according to a second embodiment, where a horizontal axis represents luminance of the pixels in the captured images and a vertical axis represents an evaluation value (differential value);

FIG. 21 is a flowchart illustrating a learning method using a learning unit in an information processing apparatus according to a third embodiment; and

FIG. 22 is a flowchart illustrating a learning method using a learning unit in an information processing apparatus according to a fifth embodiment.

### DESCRIPTION OF EMBODIMENTS

Hereinafter, embodiments of the present disclosure will be described in detail with reference to the drawings. The following description shows embodiments of the present disclosure, and the scope of the present disclosure is not limited to the following embodiments. In the following description, components with the same reference numerals indicate substantially the same content. Some reference numerals may be omitted as necessary for the sake of clarity of the drawings.

### First Embodiment

A first embodiment will be described. First, an inspection apparatus will be described, and then an image capturing apparatus and an information processing apparatus in the inspection apparatus will be described. Subsequently, an information processing method and a learning method will be described, and then an inspection method will be described.

### <Inspection Apparatus>

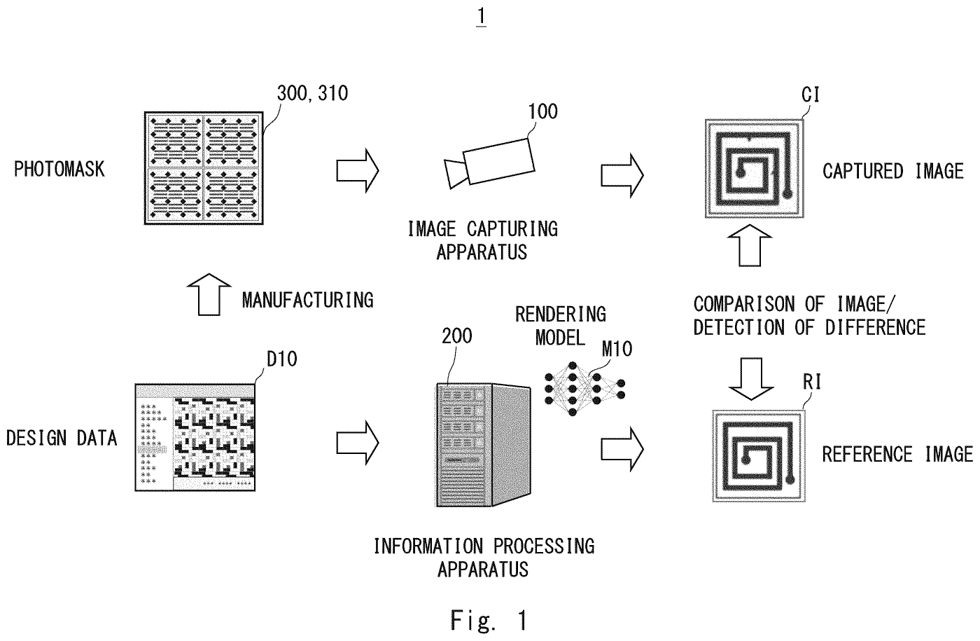

An inspection apparatus according to the first embodiment will be described. FIG. 1 is a schematic diagram illustrating the inspection apparatus according to the first embodiment. As illustrated in FIG. 1, the inspection apparatus 1 according to the present embodiment includes an image capturing apparatus 100 and an information processing apparatus 200. In FIG. 1, the image capturing apparatus 100 and the information processing apparatus 200 are shown separately. However, the inspection apparatus 1 may be integrated by incorporating the information processing apparatus 200 into the image capturing apparatus 100, or the image capturing apparatus 100 and the information processing apparatus 200 may each function as a single unit.

The inspection apparatus 1 of the present embodiment inspects an object 300. The inspection apparatus 1 inspects, for example, defects present in the object 300. The object 300 may be an EUV photomask used in lithography using EUV (Extreme Ultra Violet) light. The EUV photomask is simply referred to as an EUV mask 310. The object 300 may be a photomask used in lithography using light other than the EUV light. The object 300 is not limited to the photomask, and may also be a semiconductor apparatus as long as a pattern is formed.

In the following, the object 300 may be described as an EUV mask 310 as an example, as appropriate. In this case, the inspection apparatus 1 is an EUV mask inspection apparatus that inspects the EUV mask 310. The inspection apparatus 1 inspects the EUV mask 310 by capturing a captured image CI of the EUV mask 310 including a pattern and comparing the captured image CI with a reference image RI. An overview of the inspection performed by the inspection apparatus 1 will be described below.

(1) First, the inspection apparatus 1 converts design data D10 of the EUV mask 310 into the reference image RI. The design data D10 may include design CAD (Computer Aided Design) data. The design data D10 may include vector data. A process of converting the design data D10 into the reference image RI is referred to as rendering.

(2) Then, the inspection apparatus 1 captures an image of the EUV mask 310 using the image capturing apparatus 100 to acquire the captured image CI. Then, the inspection apparatus 1 compares and collates the captured image CI with the reference image RI. The inspection apparatus 1 detects defects in the EUV mask 310 from a difference acquired by the comparison and collation.

In the present embodiment, the inspection apparatus 1 generates and trains a rendering model M10 (converter), which performs conversion processing, before performing the process (1). The rendering model M10 may also be simply referred to as a model. The rendering model M10 is generated and trained using a technique of machine learning. The information processing apparatus 200 generates a reference image RI using the trained rendering model M10. One of features of the present embodiment relates to a method of determining completion of the training of the rendering model M10. In other words, when the rendering model M10 can output a predetermined image as the reference image RI, it is determined to be the completion of the training.

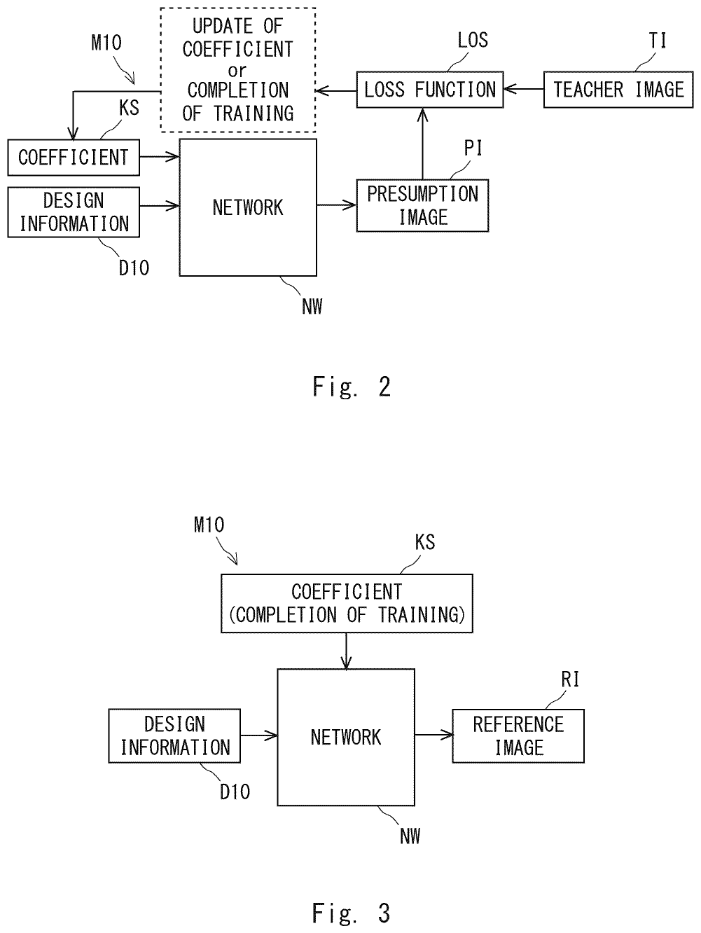

FIG. 2 is a diagram illustrating an example during training of the rendering model M10 in the information processing apparatus 200 according to the first embodiment. FIG. 3 is a diagram illustrating an example during inspection using the rendering model M10 that is completely trained in the information processing apparatus 200 according to the first embodiment.

As illustrated in FIG. 2, the information processing apparatus 200 trains the rendering model M10 during training. For example, the rendering model M10 includes a network NW such as a multilayer neural network and a coefficient KS. The rendering model M10 receives, as an input, the design data D10 of the object 300. The rendering model M10, which receives the design data D10 of the object 300 as an input, outputs an image. Hereinafter, the image output from the rendering model M10 during the training will be referred to as a generated image PI.

The present embodiment adopts a residual as a method of determining the completion of training of the rendering model M10. The residual is calculated based on a difference between the captured image CI as a training image TI and the generated image PI output from the model M10 during the training course. Specifically, the residual is calculated based on a difference (for example, a luminance difference) between information (for example, luminance) regarding each pixel in the captured image CI and information (for example, luminance) regarding each pixel in the generated image PI. In the present embodiment, when the residual satisfies a predetermined condition, the training of the rendering model M10 is completed. When the residual does not satisfy the predetermined condition, the coefficient KS is updated and the training of the rendering model M10 is continued.

The captured image CI involves a region in which noise tends to be generated due to a pattern shape or the like. The residual is more likely to occur in the region in which noise tends to be generated than a region in which noise does not tend to be generated. Generally, noise is more likely to be generated in a region in which the luminance becomes high than a region in which the luminance becomes low. The region in which the luminance becomes high is, for example, a multilayer region in the EUV mask. The region in which the luminance becomes low is, for example, an absorber portion in the EUV mask.

During the training course, the absorber region has less noise. Therefore, the absorber region contributes to reduce the residual. On the other hand, the multilayer region has more noise. Therefore, the multilayer region contributes to increase the residual. The residual between the generated image PI and the training image TI during the training course includes a residual due to a lack of training and a residual due to noise. For this reason, when the residual is calculated using a loss function LOS based on the difference between the generated image PI and the training image TI, there is a case where the training is insufficient even when the residual satisfies the predetermined condition. In particular, it is difficult to sufficiently train in the absorber region in which a pitch between patterns is narrow and a proximity effect occurs.

Therefore, weighting is performed on the difference between the generated image PI and the training image TI using magnitude of the luminance or the like as a parameter. The weighting may be calculated based on at least one of the luminance of each pixel in the generated image PI and the luminance of each pixel in the training image TI. The coefficient KS of the rendering model M10 is updated until the residual satisfies the predetermined condition. Then, the training of the rendering model M10 and the calculation of the residual continue. When the residual satisfies the predetermined condition, the training of the rendering model M10 is completed.

As illustrated in FIG. 3, the information processing apparatus 200 inputs the design data D10 of the object 300 to the trained rendering model M10 during the inspection, thereby outputting the reference image RI. Hereinafter, each component of the image apparatus and the information processing apparatus in the inspection apparatus 1 according to the present embodiment will be described.

### <Image Capturing Apparatus>

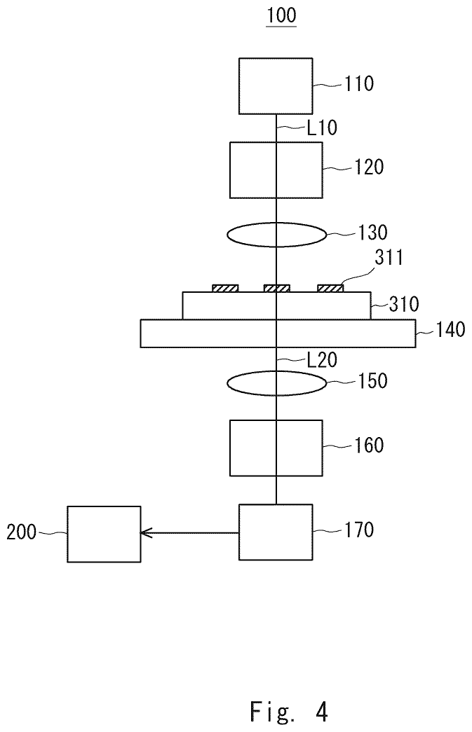

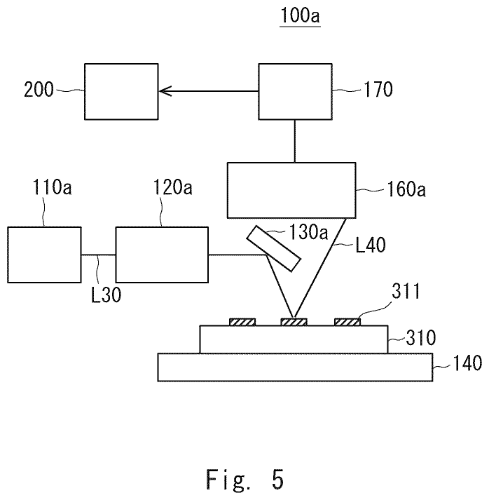

First, the image capturing apparatus 100 will be described with reference to the drawings. FIG. 4 is a configuration diagram illustrating the image capturing apparatus 100 according to the first embodiment. FIG. 5 is a configuration diagram illustrating another image capturing apparatus 100a according to the first embodiment. As illustrated in FIG. 4, the image capturing apparatus 100 may capture an image of the EUV mask 310 using transmitted illumination. In addition, as illustrated in FIG. 5, the image capturing apparatus 100a may capture an image of the EUV mask 310 using reflected illumination. As illustrated in FIG. 4, the image capturing apparatus 100 includes an illuminating light source 110, an illuminating optical system 120, a lens 130, a stage 140, a lens 150, a detecting optical system 160, and a detector 170.

In the following description, the EUV mask 310 provided with patterns 311 is used as the object 300, but the object 300 is not limited to the EUV mask 310 as long as the patterns 311 are provided, and may be a mask provided with the patterns 311 used in lithography other than the EUV light, or a semiconductor apparatus or the like. When the object 300 is the EUV mask 310, the image capturing apparatus 100 functions as an image capturing apparatus that captures an image of the EUV mask 310 provided with the patterns 311.

The illuminating light source 110 generates illuminating light L10 that illuminates the EUV mask 310. The illuminating light L10 is incident on the illuminating optical system 120 from the illuminating light source 110. The illuminating optical system 120 includes optical components, for example, a relay lens and a mirror, and guides the illuminating light L10 to the lens 130. The illuminating optical system 120 may also include an optical scanner, an autofocus (AF) function, or the like. The illuminating light L10 is condensed by the lens 130 and incident on the EUV mask 310. The lens 130 condenses the illuminating light L10 onto a pattern surface of the EUV mask 310 on which the patterns 311 are formed. In this way, the EUV mask 310 is illuminated.

Transmitted light L20 penetrating the EUV mask 310 penetrates the stage 140, which is transparent to the transmitted light L20, and is incident on the lens 150. The lens 150 is an objective lens that condenses the transmitted light L20 from the EUV mask 310. The transmitted light L20 is incident on the detecting optical system 160 through the lens 150. The detecting optical system 160 includes optical components, for example, an imaging lens and a mirror, and guides the transmitted light L20 to the detector 170. The detecting optical system 160 forms the image of the EUV mask 310 on a light receiving surface of the detector 170.

The detector 170 is a line sensor or a two-dimensional array sensor such as a CCD (Charged Coupled Device) or a CMOS (Complementary Metal Oxide Semiconductor) camera including a plurality of pixels. A TDI (Time Delay Integration) sensor can also be used as the detector 170. Therefore, the detector 170 captures an image of the EUV mask 310 provided with the patterns 311. Reflectance and transmittance for the illuminating light L10 differ depending on the presence or absence of the patterns 311. For example, in the case of the EUV mask 310, the transmittance is low in areas where the patterns 311 are present, and the transmittance is high in areas where the patterns 311 are not present. Therefore, the amount of received light changes depending on the presence or absence of the patterns 311. The magnitude of the transmittance depending on the presence or absence of the patterns is merely an example, and there may also be an opposite case.

The EUV mask 310 is placed on the stage 140. The stage 140 is an XY stage, and moves the EUV mask 310 in an X-axis direction and a Y-axis direction. Moving coordinates of the stage 140 are input to the information processing apparatus 200. Then, while the stage 140 is moving the EUV mask 310, the detector 170 captures an image of the EUV mask 310. This makes it possible to obtain a captured image CI of the whole or a desired region of the EUV mask 310. The transmittance for the illuminating light L10 differs depending on the presence or absence of the patterns 311. Therefore, a luminance value, that is, an intensity of a detection signal, differs depending on the presence or absence of the patterns 311.

The detector 170 outputs the detection signal corresponding to the amount of received light to the information processing apparatus 200. Thus, the captured image CI is input to the information processing apparatus 200. A grayscale value corresponding to the amount of received light is set for each pixel of the captured image CI. The information processing apparatus 200 performs image processing on the detection signal. For example, the information processing apparatus 200 is a computer including a processor, a memory, and the like, as will be described below.

Furthermore, as illustrated in FIG. 5, the image of the EUV mask 310 may be captured by the image capturing apparatus 100a using the reflected illumination. The image capturing apparatus 100a includes an illuminating light source 110a, an illuminating optical system 120a, a mirror 130a, a stage 140, a detecting optical system 160a, and a detector 170. When the EUV mask 310 is illuminated and captured using light with a wavelength in the EUV region as illuminating light L30, the image capturing apparatus 100a is optionally configured as a reflecting optical system.

The illuminating light source 110a generates illuminating light L30 that illuminates the EUV mask 310. The illuminating light L30 is incident on the illuminating optical system 120a from the illuminating light source 110a. The illuminating optical system 120a includes an optical component such as an ellipsoidal reflector, and guides the illuminating light L30 to the mirror 130a. The illuminating optical system 120a may also include an optical scanner, an AF function or the like. The illuminating light L30 is reflected by the mirror 130a and incident on the EUV mask 310. The mirror 130a condenses the illuminating light L30 onto a pattern surface of the EUV mask 310 on which patterns 311 are formed. In this way, the EUV mask 310 is illuminated.

Reflected light L40 reflected by the EUV mask 310 is incident on the detecting optical system 160a. The detecting optical system 160a includes an optical component such as a reflector, and guides the reflected light L40 to the detector 170. The detecting optical system 160a forms the image of the EUV mask 310 on a light receiving surface of the detector 170.

### <Information Processing Apparatus>

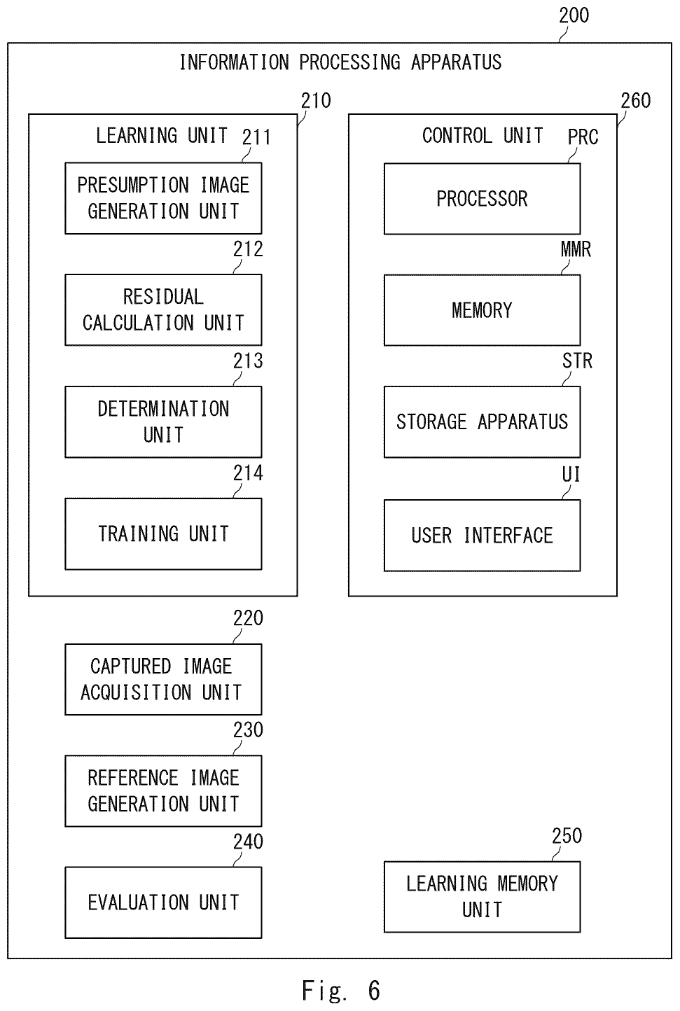

FIG. 6 is a block diagram illustrating a configuration of the information processing apparatus 200 according to the first embodiment. As illustrated in FIG. 6, the information processing apparatus 200 includes a learning unit 210, a captured image acquisition unit 220, a reference image generation unit 230, an evaluation unit 240, a learning memory unit 250, and a control unit 260. The learning unit 210 includes a generated image generation unit 211, a residual calculation unit 212, a determination unit 213, and a training unit 214. The control unit 260 includes a processor PRC, a memory MMR, a storage apparatus STR, and a user interface UI. The information processing apparatus 200 includes an information processing device such as a personal computer (PC), a server, a tablet, or the like.

First, a function of the control unit 260 will be described. The storage apparatus STR stores processing to be executed by each component of the information processing apparatus 200 in the form of a program. The processor PRC reads the program from the storage apparatus STR into the memory MMR, and executes the program. In this way, the processor PRC implements the function of each of the components in the information processing apparatus 200, for example, each of the learning unit 210, the captured image acquisition unit 220, the reference image generation unit 230, and the evaluation unit 240. The user interface UI may include an input apparatus such as a keyboard, a mouse, or an image capturing device, and an output apparatus such as a display, a printer, or a speaker.

Each of the components in the information processing apparatus 200 may each be implemented by dedicated hardware. Some or all of the components may also be implemented by a general-purpose or dedicated circuitry, a processor PRC or the like, or a combination thereof. These components may be configured by a single chip or a plurality of chips connected to each other through a bus. Some or all of the components may be implemented by a combination of the circuitry and the processor PRC or the like described above with a program. A central processing unit (CPU), a graphics processing unit (GPU), a field-programmable gate array (FPGA), a quantum processor (quantum computer control chip), or the like can be used as the processor PRC.

Further, when some or all of the components in the information processing apparatus 200 are implemented by a plurality of information processing devices, circuits, or the like, the plurality of information processing devices, circuits, or the like may be centrally arranged or may be distributed. For example, the information processing devices, the circuits, or the like may be implemented by a client-server system, a cloud computing system, or the like in a form of being connected via a communication network. Furthermore, the functions of the information processing apparatus 200 may be provided in a Saas (Software as a Service) format.

The learning unit 210 trains the rendering model M10. The learning unit 210 operates the generated image generation unit 211, the residual calculation unit 212, the determination unit 213, and the training unit 214, thereby training the rendering model M10.

The generated image generation unit 211 inputs the design data D10 of the object 300 into the rendering model M10 in the training course, thereby generating the generated image PI. As described above, the rendering model M10 involves the network NW and the coefficient KS.

The residual calculation unit 212 calculates a residual by comparing the generated image PI output from the rendering model M10 in the training course with the training image TI including the captured image CI obtained by capturing the object 300. For example, the residual calculation unit 212 calculates the residual by comparing the generated image PI output from the rendering model M10 in the training course to which the design data D10 of the object 300 is input, with the training image TI including the captured image CI obtained by capturing the object 300. Specifically, the rendering model M10 receives, as input, a design image obtained by rasterizing the design data D10 of the object 300 as the design data D10 of the object 300. The design data D10 and the design image may sometimes be simply referred to as design data D10 without discrimination.

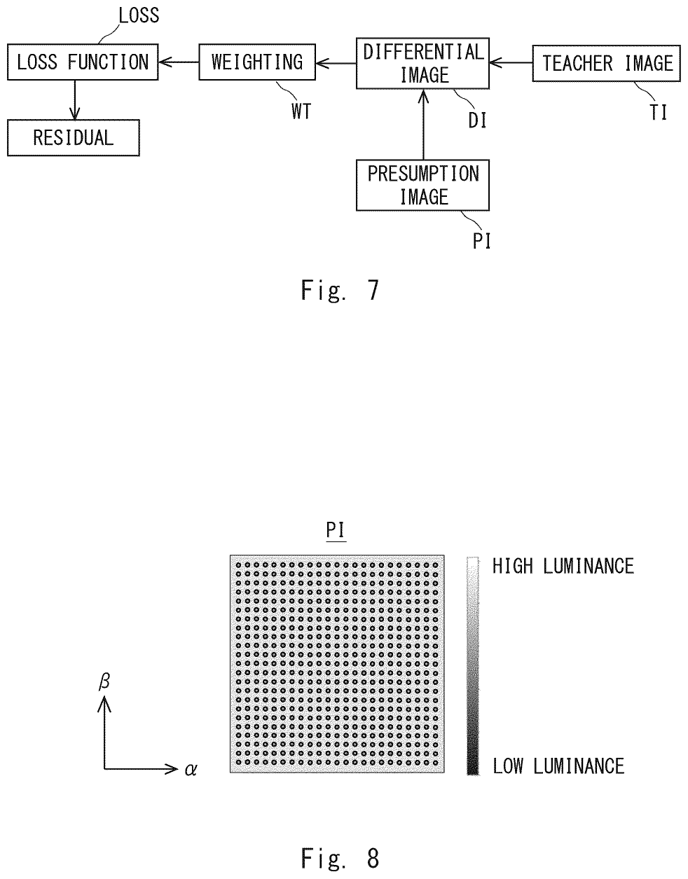

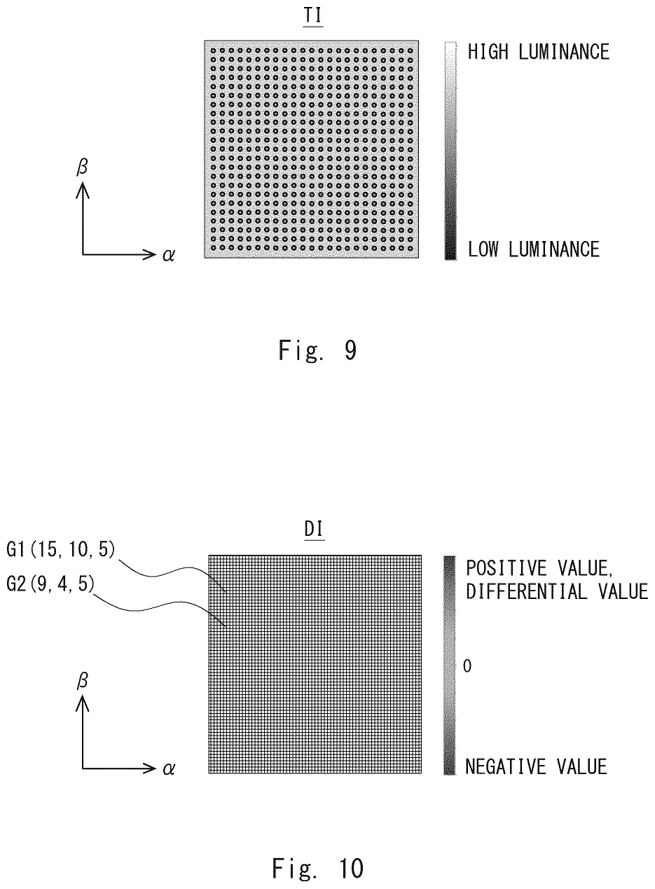

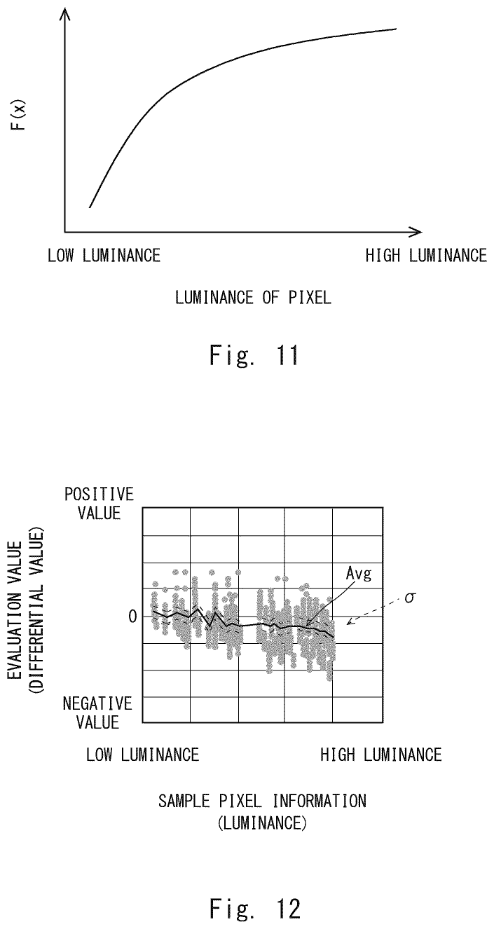

FIG. 7 is a diagram illustrating residual calculation performed by the residual calculation unit 212 in the information processing apparatus 200 according to the first embodiment. FIG. 8 is a plan view illustrating the generated image PI in the information processing apparatus 200 according to the first embodiment. FIG. 9 is a plan view illustrating the training image TI in the information processing apparatus 200 according to the first embodiment. FIG. 10 is a plan view illustrating a differential image DI in the information processing apparatus 200 according to the first embodiment. As illustrated in FIGS. 7 to 10, the residual calculation unit 212 calculates the residual based on the differential image DI obtained by the difference between the information regarding each pixel in the generated image PI and the information regarding each pixel in the training image TI.

The generated image PI is output from the rendering model M10 in the training course to which the design data D10 of the object 300 is input. The generated image PI may be a partial region of a larger image output from the rendering model M10. The generated image PI may include a plurality of pixels arranged in a matrix, for example. In the generated image PI, one direction is an α-axis direction in which the pixels are arranged, and a direction intersecting the α-axis direction is a β-axis direction. The generated image PI may include a plurality of pixels with L rows arranged in the α-axis direction and M columns arranged in the β-axis direction. Each of the pixels in the generated image PI has information regarding the pixel. The information regarding each pixel in the generated image PI involves luminance of the pixel, for example.

The “each pixel” may mean all pixels that form an image, or may mean some of the pixels (but, a plurality of pixels) that form the image. In the present embodiment, unless otherwise specified, the expression of “each pixel” is used, assuming that either meaning is acceptable.

The training image TI may include the captured image CI. The training image TI may be a partial region of the captured image CI obtained by capturing the object 300. The training image TI may include a plurality of pixels arranged in a matrix, for example. In the training image TI, one direction is an α-axis direction in which the pixels are arranged, and a direction intersecting the α-axis direction is a β-axis direction. The training image TI may include a plurality of pixels with L rows arranged in the α-axis direction and M columns arranged in the β-axis direction. Each of the pixels in the training image TI has information regarding the pixel. The information regarding each pixel in the training image TI involves luminance of the pixel, for example.

The residual calculation unit 212 generates the differential image DI between the generated image PI and the training image TI. The differential image DI may include a plurality of pixels arranged in a matrix, for example. In the differential image DI, one direction is an α-axis direction in which the pixels are arranged, and a direction intersecting the α-axis direction is a β-axis direction. The differential image DI may include a plurality of pixels with L rows arranged in the α-axis direction and M columns arranged in the β-axis direction. Each of the pixels in the differential image DI has information regarding the pixel. The information regarding each pixel in the differential image DI involves an evaluation value, for example. The differential image DI may be data containing information capable of being used for image generation, and thus it is called the differential image DI. However, differential image DI may be information used for evaluation of the residual, and therefore the differential image DI does not necessarily need to be displayed on a display unit or the like such that a user can recognize it as an image. Therefore, the differential image DI may also be called differential data.

The evaluation value is a value obtained by the difference between the information regarding each pixel in the generated image PI and the information regarding each pixel in the training image TI corresponding to each pixel in the generated image PI. The pixel in the training image TI corresponding to the pixel in the generated image PI indicates that a position of the pixel in the generated image PI on the α-axis and the β-axis is the same as a position of the pixel in the training image TI on the α-axis and the β-axis. The evaluation value includes, for example, a luminance difference obtained by the difference between the luminance of each pixel in the generated image PI and the luminance of each pixel in the training image TI. Therefore, each pixel in the differential image DI has the evaluation value including the luminance difference as information regarding the pixel. Further, each pixel in the differential image DI may further include, as information regarding the pixel, information regarding the pixel in the corresponding generated image PI and information regarding the pixel in the corresponding training image TI.

For example, when the luminance of the pixel in the corresponding generated image PI is 15, the luminance of the pixel in the corresponding training image TI is 10, and the luminance difference thereof is 5, a pixel G1 in the corresponding differential image DI may include G1 (15, 10, 5) as information regarding the pixel G1.

Furthermore, when the luminance of the pixel in the corresponding generated image PI is 9, the luminance of the pixel in the corresponding training image TI is 4, and the luminance difference thereof is 5, a pixel G2 in the corresponding differential image DI may include G2 (9, 4, 5) as information regarding the pixel G2.

The residual calculation unit 212 performs weighting on the evaluation value of each pixel in the differential image DI. The residual calculation unit 212 determines, as a first pixel, a pixel in the differential image DI corresponding to a pixel whose pixel information (which may be referred to as sample pixel information) based on at least one of the information (for example, luminance) regarding the pixel in the generated image PI and the information (for example, luminance) regarding the pixel in the training image TI indicates first luminance. The residual calculation unit 212 determines, as a second pixel, a pixel in the differential image DI corresponding to a pixel whose pixel information based on at least one of the information (for example, luminance) regarding the pixel in the generated image PI and the information (for example, luminance) regarding the pixel in the training image TI indicates second luminance. A pixel other than the first pixel may be the second pixel. For example, the second luminance is smaller than the first luminance. In other words, the first luminance is larger than the second luminance. The residual calculation unit 212 performs different weightings on an evaluation value of the first pixel in the differential image DI and an evaluation value of the second pixel in the differential image DI. The first luminance and the second luminance may include a predetermined luminance range.

The sample pixel information is information (for example, luminance) regarding the pixel based on at least one of the information (for example, luminance) regarding the pixel in the generated image PI and the information (for example, luminance) regarding the pixel in the training image TI corresponding to the pixel in the generated image PI. The sample pixel information is, for example, whichever is greater luminance, the luminance of the pixel in the generated image PI and the luminance of the pixel in the training image TI corresponding to the pixel in the generated image PI. The sample pixel information may be determined, under predetermined conditions, based on at least one of the information regarding the pixel in the generated image PI and the information regarding the pixel in the training image TI corresponding to the pixel in the generated image PI. Out of the luminance of the pixel in the generated image PI and the luminance of the pixel in the training image TI, the luminance, which makes it easier to see the difference value of defects, may be used as the sample pixel information. Furthermore, the sample pixel information may be determined according to the progress of training of the rendering model M10. For example, at the beginning of the training, the luminance of the pixel in the training image TI may be determined as the sample pixel information, and at the end of training, the luminance of the pixel in the generated image PI may be determined as the sample pixel information. Here, the progress of training of the rendering model M10 may be evaluated based on the magnitude of the value of the residual LS, which will be described below. The sample pixel information may be an average value, a weighted average value, or the like of the information (for example, luminance) regarding the pixel in the generated image PI and the information (for example, luminance) regarding the pixel in the training image TI corresponding to the pixel in the generated image PI. The weighting in the weighted average value may be changed according to the progress of training of the rendering model M10.

For example, the sample pixel information is assumed to be the greater of the luminance of the pixel in the generated image PI and the luminance of the pixel in the training image TI. The first luminance is set to be equal to or larger than 10 and less than 20, and the second luminance is set to be equal to or larger than 0 and less than 10. Then, for the pixel G1 (15, 10, 5) in the differential image DI described above, the luminance of the pixel in the corresponding generated image PI is 15, and the luminance of the pixel in the corresponding training image TI is 10. Therefore, the sample pixel information is 15, and the pixel G1 in the differential image DI is the first pixel. For the pixel G2 (9, 4, 5) in the differential image DI described above, the luminance of the pixel in the corresponding generated image PI is 9, and the luminance of the pixel in the corresponding training image TI is 4. Therefore, the sample pixel information is 9, and the pixel G2 in the differential image DI is the second pixel. Therefore, the residual calculation unit 212 performs different weightings on the evaluation value (5) of the pixel G1 in the differential image DI and the evaluation value (5) of the pixel G2 in the differential image DI.

FIG. 11 is a graph illustrating a function used for weighting by the residual calculation unit 212 in the information processing apparatus 200 according to the first embodiment, where a horizontal axis represents luminance and a vertical axis represents a correction coefficient as weighting. As illustrated in FIG. 11, the residual calculation unit 212 may use a correction coefficient F(x) indicated by Formula (1) below as an example of weighting on the evaluation value.

In this Formula, “a” and “b” are constants that depend on the specification of the inspection apparatus 1. A symbol “x” represents luminance as sample pixel information.

$$F ( x ) = 1 - a \times exp ( - b \times x ) \qquad ( 1 )$$

F(x) is a function that takes on a larger value as the luminance becomes higher. F(x) approaches 1 as the luminance becomes higher. By adjustment of values of “a” and “b”, a relationship of F(x)>0 is established when x is equal to or larger than 0.

The residual calculation unit 212 performs weighting on the evaluation value of each pixel in the differential image DI using Formula (2) below to calculate a corrected evaluation value L. The weighted evaluation value is called the corrected evaluation value L. In this Formula, “diff” indicates an evaluation value such as the luminance difference of each pixel in the differential image DI. K is a constant that depends on the specification of the inspection apparatus 1 or the like.

$$\begin{matrix}L ( diff , x ) = K \times diff / F ( x ) \\ = K \times diff / \{ 1 - a \times exp ( - b \times x ) \}\end{matrix} \qquad ( 2 )$$

The residual calculation unit 212 may calculate the corrected evaluation value L based on a standard deviation σ(x) of diff as indicated by Formula (3) below instead of Formula (2). In this Formula, “diffₐᵥₑₓ” represents an average value of diff in a set of pixels whose luminance as the sample pixel information is x.

$$L ( diff , x ) = K \times ( diff - diffavex ) / σ ( x ) \qquad ( 3 )$$

According to Formula (3) above, the residual calculation unit 212 calculates the corrected evaluation value L by standardizing the evaluation value such as the luminance difference with respect to the luminance x.

FIG. 12 is a graph illustrating a distribution of evaluation values (diff) (differential values, for example, luminance differences) for the differential image DI before the weighting is performed in the information processing apparatus 200 according to the first embodiment, where a horizontal axis represents the sample pixel information (luminance) and a vertical axis represents the evaluation value (diff) (differential value, for example, the luminance difference). FIG. 13 is a graph illustrating a distribution of corrected evaluation values L for the differential image DI after the weighting is performed in the information processing apparatus 200 according to the first embodiment, where a horizontal axis represents the sample pixel information (luminance) and a vertical axis represents the corrected evaluation value L. As illustrated in FIG. 12, the residual calculation unit 212 may acquire the average value diffavex of the differential values and the standard deviation σ(x) of the differential values diff for each luminance range in which the luminance of the pixel has a width of +1, for example.

As illustrated in FIGS. 12 and 13, the residual calculation unit 212 divides the evaluation value of the first pixel corresponding to a pixel whose sample pixel information indicates the first luminance (>second luminance) by a large F(x) (Formula (2)) or standardizes it based on the standard deviation σ (Formula (3)). This makes it possible to underrate the evaluation value of the first pixel in the differential image DI. On the other hand, the residual calculation unit 212 divides the evaluation value of the second pixel corresponding to a pixel whose sample pixel information indicates the second luminance (<first luminance) by a small F(x) (Formula (2)) or standardizes it based on the standard deviation σ (Formula (3)). This makes it possible to overrate the evaluation value of the second pixel in the differential image DI. In this way, the residual calculation unit 212 divides the evaluation value (diff) for the differential image DI by a function of x (for example, F(x) described above), which has a value larger than 0 and monotonically increases with respect to the luminance x, to calculate the corrected evaluation value L that is corrected by performing different weightings on the evaluation value of the first pixel and the evaluation value of the second pixel. Alternatively, the residual calculation unit 212 standardizes the evaluation value (diff) for the differential image DI by the luminance x to calculate the corrected evaluation value L that is corrected by performing different weightings on the evaluation value of the first pixel and the evaluation value of the second pixel. A variation in the evaluation value (diff) for the differential image DI varies depending on the luminance x. Therefore, standardizing the evaluation value of the first pixel and the evaluation value of the second pixel by the luminance x can be said to correct the evaluation value (diff) for the differential image DI by different weightings according to the variation in the evaluation value.

The residual calculation unit 212 may classify the sample pixel information (luminance) into three or more levels of luminance, for example, first luminance>second luminance>third luminance, and so on. Furthermore, the residual calculation unit 212 may classify the pixels in the differential image DI corresponding to pixels having luminance of the sample pixel information (luminance) into three or more pixels, for example, a first pixel, a second pixel, a third pixel, and so on. The residual calculation unit 212 may perform a predetermined weighting on the evaluation value of the first pixel, the evaluation value of the second pixel, the evaluation value of the third pixel, and so on. This makes it possible to overrate or underrate the evaluation values of the first pixel, the second pixel, the third pixel, and so on in the differential image DI by a predetermined ratio.

As illustrated in FIG. 13, the residual calculation unit 212 performs different weighting on the evaluation value of the first pixel in the differential image DI and the evaluation value of the second pixel in the differential image DI, thereby calculating the corrected evaluation value. For example, the residual calculation unit 212 performs a larger weighting on the evaluation value of the second pixel than on the evaluation value of the first pixel. This makes it possible to make uniform a variation in the corrected evaluation value in the first pixel and a variation in the corrected evaluation value in the second pixel.

The residual calculation unit 212 performs arithmetic processing on the corrected evaluation value to calculate the residual of the differential image DI. The residual calculation unit 212 may calculate and acquire the residual of the differential image DI based on the corrected evaluation value. The residual calculation unit 212 may consider the corrected evaluation value to be the residual of the differential image DI. The residual calculation unit 212 may calculate the residual from a plurality of reference values VA to VD. The reference value VA is, for example, a maximum value of the corrected evaluation values of the plurality of pixels in the differential image DI. The reference value VB is an average value of the corrected evaluation values of the plurality of pixels in the differential image DI. The reference value VC is a maximum value of the corrected evaluation values of the plurality of pixels corresponding to a pattern edge portion of the differential image DI. The reference value VD is an average value of the corrected evaluation values of the plurality of pixels corresponding to the pattern edge portion of the differential image DI. The reference values are not limited to the four reference values VA to VD.

The residual calculation unit 212 calculates a single value, the residual LS using Formula (4) with coefficients J1 to J4 for the reference values VA to VD, respectively.

$$LS = ( J 1 \times VA ) + ( J 2 \times VB ) + ( J 3 \times VC ) + ( J 4 \times VD ) \qquad ( 4 )$$

In this way, the residual calculation unit 212 may perform arithmetic processing on at least one of the average value of the corrected evaluation values of the plurality of pixels including the first pixel and the second pixel in the differential image DI and the maximum value of the corrected evaluation values of the plurality of pixels, thereby calculating the residual LS of the differential image DI.

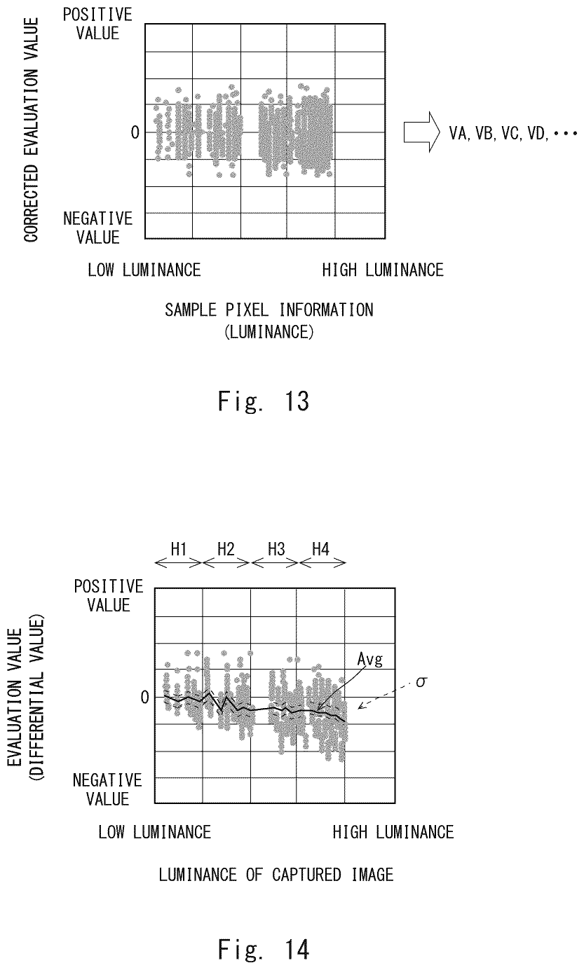

FIG. 14 is a graph illustrating a distribution of corrected evaluation values (differential values) of pixels in a differential captured image obtained by the difference between the captured images CI in the information processing apparatus 200 according to the first embodiment, where a horizontal axis represents the luminance of the pixels in the captured images CI and a vertical axis represents the evaluation value (differential value). As illustrated in FIG. 14, the residual calculation unit 212 may acquire, for a plurality of pixels in the captured image CI, statistical values indicating the degree of variation in information regarding the pixels between the plurality of captured images CI, based on a comparison of the plurality of captured images CI for substantially same regions of the object 300. Then, the residual calculation unit 212 calculates the weighting for the evaluation value of the differential image based on the acquired statistical value. Specifically, as an example, the residual calculation unit 212 may acquire the weighting by calculating, in advance, the statistical value of the evaluation values (differential values) of the plurality of pixels in the differential captured image obtained by the difference between the information regarding each pixel in the plurality of captured images CI. The substantially same regions include, for example, regions that have the same design information but different coordinates on the object 300, or regions that belong to different dies on the object 300 (for example, a photomask) but have the same relative coordinates within the die. The statistical value includes, for example, the standard deviation and the average value. Then, the residual calculation unit 212 may calculate the weighting for the evaluation value of the pixel in the differential image DI, based on the acquired statistical value. In other words, the residual calculation unit 212 may acquire the weighting for the evaluation value of the pixel in the differential image DI by calculating F(x) and the standard deviation σ(x) for the differential captured image based on the statistical values of the evaluation values of the plurality of pixels in the differential captured image. The residual calculation unit 212 may calculate a corrected evaluation value by applying the acquired F(x) and standard deviation σ(x) to the evaluation value (diff) for the pixel in the differential image DI between the training image TI and the generated image PI.

In addition, the residual calculation unit 212 may acquire the weighting for the evaluation value of the pixel in the differential image DI by calculating, in advance, a luminance-by-luminance statistical value of the luminance difference between the plurality of pixel in the differential captured image obtained by the difference between the luminance of each pixel in the plurality of captured images CI. The term “luminance-by-luminance” may also refer to a certain range of luminance. For example, the residual calculation unit 212 may calculate and acquire the luminance-by-luminance statistical value for a range H1, a range H2, a range H3, and a range H4 illustrated in FIG. 14. Then, the residual calculation unit 212 may calculate a luminance-by-luminance weighting for the luminance difference in the differential image DI based on the acquired luminance-by-luminance statistical value.

As will be described below, the residual calculation unit 212 may acquire statistical values from a processing unit that calculates statistical values by implementing various types of statistical processing.

When the residual LS satisfies a predetermined condition, the determination unit 213 determines that the training of the rendering model M10 is completed.

The training unit 214 trains the rendering model M10 using the generated image PI and the training image TI.

The captured image acquisition unit 220 acquires the captured image CI from the image capturing apparatus 100. The captured image acquisition unit 220 acquires the captured image CI based on a detection signal from the detector 170 of the image capturing apparatus 100. The captured image acquisition unit 220 associates the coordinates of the stage 140 with the intensity of the detection signal to acquire a two-dimensional image of the EUV mask 310. The captured image CI is an image acquired by capturing an image of the object 300. The captured image acquisition unit 220 may acquire the captured image CI, which is stored in advance in a storage medium such as the storage apparatus STR, from the storage apparatus STR.

The reference image generation unit 230 generates the reference image RI based on the design data D10 of the object 300 such as the EUV mask 310. The reference image generation unit 230 may generate the reference image RI based on the design data D10 of the object 300 and the trained rendering model M10. Specifically, the reference image generation unit 230 generates the reference image RI from the design data D10, using the rendering model M10 learned by the learning unit 210. In other words, the reference image generation unit 230 generates the reference image RI by applying the rendering model M10, which is learned by the learning unit 210 and is a converter that performs conversion processing, to the design data D10.

The evaluation unit 240 evaluates the object 300 such as the EUV mask 310 based on a comparison between the reference image RI and the captured image CI.

The learning memory unit 250 may store teacher data used for learning by the learning unit 210. The learning memory unit 250 may store coefficients of the rendering model M10 learned by the learning unit 210.

### <Information Processing Method>

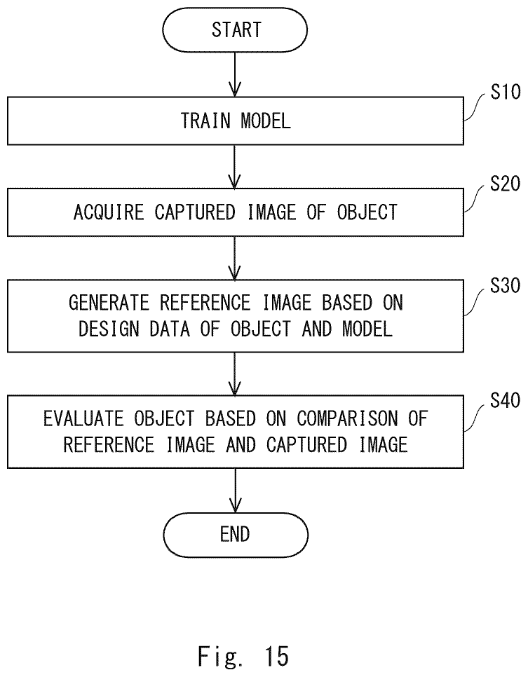

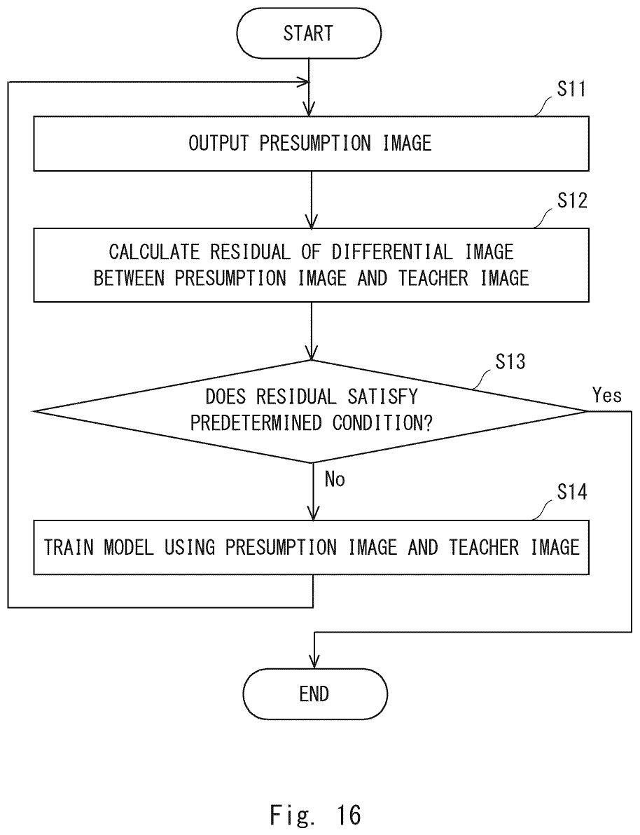

Next, an information processing method will be described which is performed by the information processing apparatus 200 in the inspection apparatus according to the present embodiment. FIG. 15 is a flowchart illustrating the information processing method using the information processing apparatus 200 according to the first embodiment. As illustrated in FIG. 15, the information processing method according to the present embodiment includes step S10 of training a model, step S20 of acquiring an captured image CI of an object 300, step S30 of generating a reference image RI based on design data D10 and a rendering model M10 of the object 300, and step S40 of evaluating the object 300 based on a comparison between the reference image RI and the captured image CI.

In step S10, the learning unit 210 trains the rendering model M10. Specifically, the learning unit 210 trains the rendering model M10 using the generated image PI and the captured image CI of the object 300 as a training image TI. The learning unit 210 trains the rendering model M10 until the determination unit 213 determines that the training of the rendering model M10 is completed.

In step S20, the captured image acquisition unit 220 acquires the captured image CI of the object 300 captured by the image capturing apparatus 100, for example. The captured image acquisition unit 220 may acquire the captured image CI stored in the storage medium such as the storage apparatus STR.

In step S30, the reference image generation unit 230 generates the reference image RI based on the design data D10 of the object 300 and the trained rendering model M10. In addition, step S30 may be implemented before step S20.

In step S40, the evaluation unit 240 compares the reference image RI with the captured image CI, and evaluates defects and the like contained in the object 300 from the difference between the two images.

### <Learning Method>

Next, a learning method using the learning unit 210 according to the present embodiment will be described. FIG. 16 is a flowchart illustrating the learning method using the learning unit 210 in the information processing apparatus 200 according to the first embodiment. As illustrated in FIG. 16, the learning method of the present embodiment includes step S11 of outputting the generated image PI, step S12 of calculating a residual LS of a differential image DI between the generated image PI and the training image TI, step S13 of determining whether the residual LS satisfies a predetermined condition, and step S14 of training the rendering model M10 using the generated image PI and the training image TI.

In step S11, the generated image generation unit 211 inputs the design data D10 of the object 300 to the rendering model M10 in the training course, thereby generating the generated image PI.

In step S12, the residual calculation unit 212 calculates the residual by comparing the generated image PI output from the rendering model M10 in the training course to which the design data D10 of the object 300 is input, with the training image TI including the captured image CI of the object 300. Specifically, the residual calculation unit 212 calculates the residual based on the differential image DI obtained by the difference between the information regarding each pixel in the generated image PI and the information regarding each pixel in the training image TI.

In step S13, the determination unit 213 determines whether the residual satisfies a predetermined condition. When the residual satisfies the predetermined condition in step S13 (a case of Yes), the determination unit 213 determines that the training of the rendering model M10 is completed. In this case, the process ends. On the other hand, when the residual does not satisfy the predetermined condition in step S13 (a case of No), the determination unit 213 determines that the training of the rendering model M10 is not completed. In this case, the process proceeds to step S14.

In step S14, the training unit 214 trains the rendering model M10 using the generated image PI and the training image TI. Then, the process returns to step S11, and steps S11 to S13 are implemented.

Next, a residual calculation method performed by the residual calculation unit 212 will be described. FIG. 17 is a flowchart illustrating the residual calculation method performed by the residual calculation unit 212 in the inspection apparatus 1 according to the first embodiment. As illustrated in FIG. 17, the residual calculation method performed by the residual calculation unit 212 includes step S21 of calculating an evaluation value of each pixel in the differential image DI, step S22 of calculating a corrected evaluation value by performing a weighting, and step S23 of calculating a residual LS of the differential image DI using the corrected evaluation value.

In step S21, the residual calculation unit 212 calculates the corrected evaluation value, which is corrected by performing different weightings on the evaluation value of the first pixel in the differential image DI corresponding to the pixel whose pixel information based on at least one of the information regarding the pixel in the generated image PI and the information regarding the pixel in the training image TI indicates the first luminance, and the evaluation value of the second pixel in the differential image DI corresponding to the pixel whose pixel information based on at least one of the information regarding the pixel in the generated image PI and the information regarding the pixel in the training image TI indicates the second luminance. The residual calculation unit 212 may apply a larger weighting to the evaluation value of the second pixel than to the evaluation value of the first pixel.

The residual calculation unit 212 may acquire a statistical value indicating the degree of variation in the information regarding the pixel among the plurality of captured images CI for the plurality of pixels of the captured images CI based on the comparison of the plurality of captured images CI for the substantially same region of the object 300. Then, the residual calculation unit 212 calculates the weighting for the evaluation value of the differential image based on the acquired statistical value. Specifically, as an example, the residual calculation unit 212 may acquire the weighting by calculating, in advance, the statistical value of the evaluation values of the plurality of pixels in the differential captured image obtained by the difference between the information regarding each pixel in the plurality of captured images CI. Then, the residual calculation unit 212 may calculate the weighting for the evaluation value of the differential image DI based on the acquired statistical value. Furthermore, the residual calculation unit 212 may acquire the weighting by calculating, in advance, a luminance-by-luminance statistical value of the luminance difference between the plurality of pixel in the differential captured image obtained by the difference between the luminance of each pixel in the plurality of captured images CI. Then, the residual calculation unit 212 may calculate a luminance-by-luminance weighting for the luminance difference in the differential image DI based on the acquired statistical value. In addition, the residual calculation unit 212 may acquire statistical values from a processing unit that calculates statistical values by implementing various types of statistical processing.

In step S23, the residual calculation unit 212 performs arithmetic processing on the corrected evaluation value to calculate the residual of the differential image DI. The residual calculation unit 212 performs arithmetic processing on at least one of the average value of the corrected evaluation values of the plurality of pixels and the maximum value of the corrected evaluation values of the plurality of pixels to calculate the residual of the differential image DI. The residual calculation unit 212 may calculate or acquire the residual of the differential image DI based on the corrected evaluation value. The residual calculation unit 212 may determine the corrected evaluation value as the residual of the differential image DI.

### <Inspection Method>

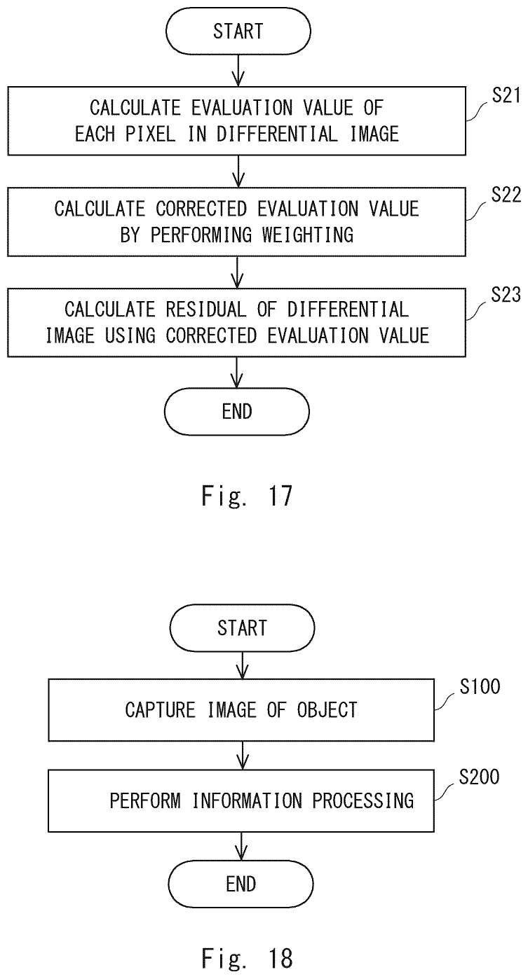

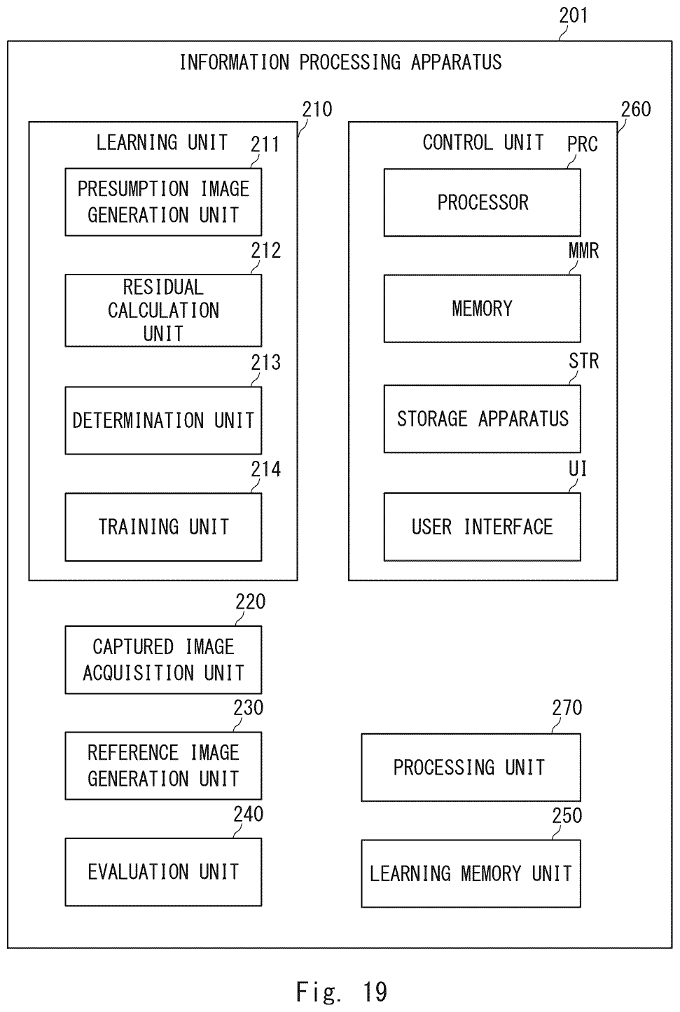

Next, an inspection method according to the first embodiment will be described. FIG. 18 is a flowchart illustrating the inspection method according to the first embodiment. As illustrated in FIG. 18, the inspection method of the present embodiment includes step S100 of capturing an image of the object 300 and step S200 of performing the information processing with the information processing method described above.

Next, effects of the present embodiment will be described. The inspection apparatus 1 of the present embodiment determines that the training of the rendering model M10 is completed when the residual of the differential image DI satisfies a predetermined condition. At this time, the residual calculation unit 212 calculates the residual LS by performing different weightings on the evaluation value of the first pixel in the differential image DI corresponding to the pixel whose sample pixel information indicates the first luminance and the evaluation value of the second pixel in the differential image DI corresponding to the pixel whose sample pixel information indicates the second luminance. Therefore, the evaluation value of the first pixel, which has large sample pixel information (luminance) and is likely to contain noise, can be underrated. On the other hand, the evaluation value of the second pixel, which has small sample pixel information (luminance) and is unlikely to contain noise, can be overrated. This makes it possible to make uniform the training level of the region in which noise does not tend to be generated and the region in which noise tends to be generated. Therefore, it is possible to train the rendering model M10 while preventing the influence of noise. In this way, the information processing apparatus 200 can improve the ability to deal with regions in which noise tends to be generated.

The residual calculation unit 212 calculates a weighting for a statistical value indicating the degree of variation in information regarding the pixels between the plurality of captured images CI, based on a comparison of the plurality of captured images CI for substantially same regions of the object 300. Specifically, for example, the residual calculation unit 212 calculates, in advance, a weighting for the statistical value of the evaluation values of the plurality of pixels in the differential captured image obtained by the difference between the information regarding each pixel in the plurality of captured images CI. Thus, the accuracy of the corrected evaluation value can be improved, and thus the accuracy of the reference image RI output from the rendering model M10 can be improved. Furthermore, the residual calculation unit 212 calculates a luminance-by-luminance weighting for the luminance difference in the differential image DI based on the luminance-by-luminance statistical value of the luminance difference of the plurality of pixels in the differential captured image. Thus, the accuracy of the corrected evaluation value can be further improved, and thus the accuracy of the reference image RI output from the rendering model M10 can be further improved.

### <Modified Example>

FIG. 19 is a block diagram illustrating a configuration of an information processing apparatus 201 according to a modified example of the first embodiment. As illustrated in FIG. 19, the information processing apparatus 201 of the present modified example further includes a processing unit 270, as compared to the information processing apparatus 200 of the first embodiment. The processing unit 270 performs various types of statistical processing to calculate a statistical value. For example, the processing unit 270 may calculate statistical values of evaluation values for a plurality of pixels in a differential captured image obtained by the difference of information regarding each pixel in a plurality of captured image CI in advance. In addition, the processing unit 270 may calculate F(x) and a standard deviation σ(x) for the differential captured image, based on the statistical values for the plurality of pixels in the differential captured image. Furthermore, the processing unit 270 may calculate, in advance, a luminance-by-luminance statistical value of a luminance difference between a plurality of pixel in the differential captured image obtained by the difference between the luminance of each pixel in the plurality of captured images CI. The processing unit 270 outputs the calculation results to the residual calculation unit 212. Thus, the residual calculation unit 212 can acquire various statistical values or the like.

According to the present modified example, the processing unit 270 calculates the statistical values or the like. Therefore, the residual calculation unit 212 does not need to calculate the statistical values or the like, and thus the processing load on the residual calculation unit 212 can be reduced. This makes it possible to improve performance of the information processing apparatus 201.

### Second Embodiment

Next, a second embodiment will be described. In the above-described embodiment, the residual calculation unit 212 calculates the luminance-by-luminance weighting for the luminance difference in the differential image DI based on the luminance-by-luminance statistical value of the luminance difference between the plurality of pixel in the differential captured image. In the present embodiment, the residual calculation unit 212 acquires a pattern-by-pattern statistical value of the luminance difference between the plurality of pixel in the differential captured image. Then, the residual calculation unit 212 calculates a pattern-by-pattern weighting for the luminance difference in the differential image DI based on the acquired statistical value. In addition, the residual calculation unit 212 may acquire the statistical value by calculation, or may acquire the statistical value calculated by the processing unit 270.

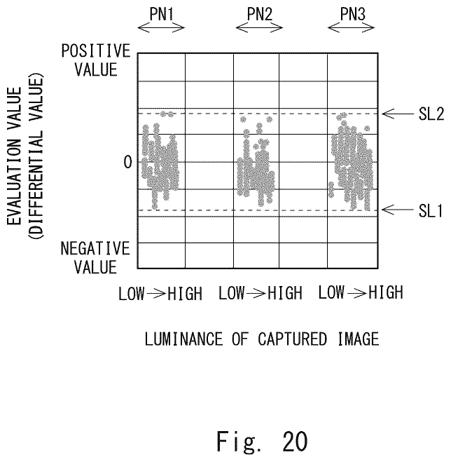

FIG. 20 is a graph illustrating a distribution of evaluation values (differential values) of pixels in a differential captured image obtained by the difference between the captured images in the information processing apparatus 200 according to the second embodiment, where a horizontal axis represents the luminance of the pixels in the captured images CI and a vertical axis represents the evaluation value (differential value). FIG. 20 illustrates a distribution of evaluation values (differential values) for each pattern 311 of the object 300. As illustrated in FIG. 20, the residual calculation unit 212 may acquire statistical values of the luminance difference for each pattern such as pattern PN1, pattern PN2, or pattern PN3 illustrated in FIG. 20. Then, the residual calculation unit 212 may calculate a weighting for the luminance difference for each pattern in the differential image DI based on the acquired statistical values of the luminance difference for each pattern.

According to the present embodiment, the residual calculation unit 212 calculates the weighting for the luminance difference for each pattern in the differential image DI based on the statistical values acquired for each pattern of the luminance difference between the plurality of pixels in the differential captured image. Therefore, it is possible to improve the ability to deal with the pattern 311 corresponding to a region in which noise tends to be generated. Other components and effects are included in the description of the first embodiment.

### Third Embodiment

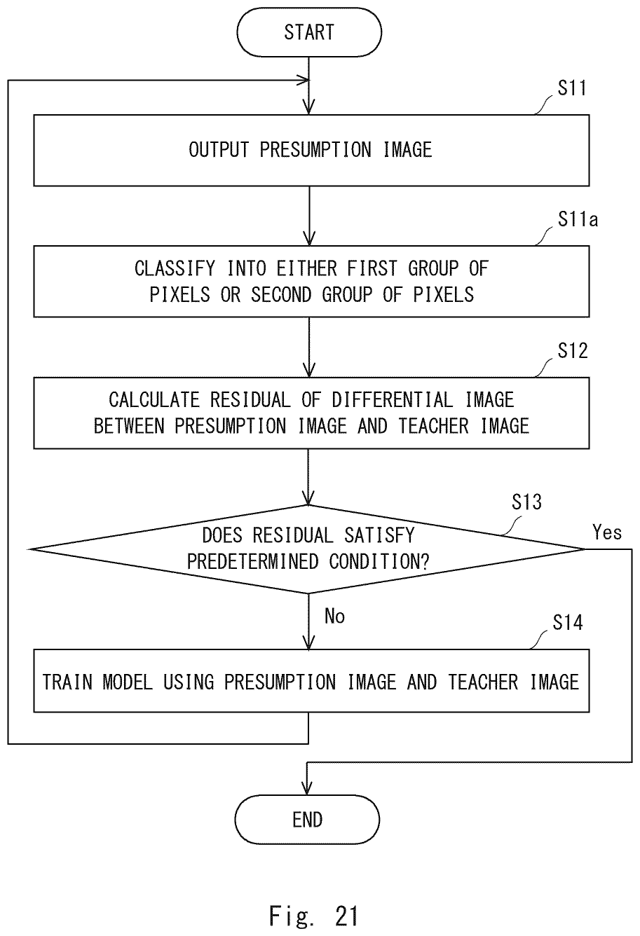

Next, a learning method according to a third embodiment will be described. FIG. 21 is a flowchart illustrating a learning method using a learning unit 210 in an information processing apparatus 201 according to the third embodiment. As illustrated in FIG. 21, the learning method of the present embodiment further includes step S11a of classifying pixels into either a first group of pixels or a second group of pixels, as compared to the learning method of the first embodiment illustrated in FIG. 16.

In step S11a, the processing unit 270 classifies the plurality of pixels in the captured image CI into either a first group of pixels or a second group of pixels, based on a comparison of the plurality of captured images CI with respect to a substantially same region of the object 300. Here, the processing unit 270 defines the second group of pixels as pixels having smaller variation in information regarding the pixels among the plurality of captured images CI with respect to the substantially same region of the object 300 than the first group of pixels. In addition, the processing unit 270 may classify the degree of variation into three or more groups, for example, a third group of pixels in addition to the first group of pixels and the second group of pixels.

In the present embodiment as described above, in the case of the comparison of the plurality of captured images CI, the captured images CI are classified into images with large variations in information regarding the pixel (for example, luminance) and images with small variations. The magnitude of the variation may vary depending on the luminance. Furthermore, the magnitude of the variation may vary depending on the pattern 311. Therefore, the processing unit 270 may classify the magnitude of variation, which depends on the luminance, into a first group or a second group, or may classify the magnitude of variation, which depends on the pattern, into a first group or a second group.

In step S12, the residual calculation unit 212 calculates the residual based on the differential image DI obtained by the difference between the information regarding each pixel in the generated image PI and the information regarding each pixel in the training image TI. In the present embodiment, the residual calculation unit 212 calculates a corrected evaluation value by performing different weightings on an evaluation value of a first pixel corresponding to the first group of pixels in the differential image DI and an evaluation value of a second pixel corresponding to the second group of pixels in the differential image DI. Here, the residual calculation unit 212 may calculate the corrected evaluation value by performing the weighting according to the degree of variation. For example, the residual calculation unit 212 may perform the weighting using the variation calculated by the processing unit 270 based on the comparison of the plurality of captured images CI. In other words, the residual calculation unit 212 may perform the different weighting according to the degree of variation by standardizing the evaluation values of the pixels in the differential image DI corresponding to the pixels at a common position, based on the standard deviation o or the average value of the luminance of the pixel at the common position in the plurality of captured images CI with respect to the substantially same region of the object 300. Alternatively, the residual calculation unit 212 may perform different weighting according to the degree of variation by standardizing the evaluation values of the pixels in the differential image DI corresponding to the pixels belonging to a common pattern, based on the standard deviation o or the average value of the luminance of the pixel belonging to the common pattern in the plurality of captured images CI with respect to the substantially same region of the object 300. Other steps and components are included in the descriptions of the first and second embodiments and the modified example which are described above.

According to the present embodiment, the corrected evaluation value is calculated according to the variation in information regarding the pixel, and thus the accuracy of the corrected evaluation value can be further improved.

### Fourth Embodiment

Next, a learning method according to a fourth embodiment will be described. In the present embodiment, as in step S11a described above, the processing unit 270 classifies the pixels into either the first group of pixels or the second group of pixels.

On the other hand, in step S12 of calculating the residual in the present embodiment, the residual calculation unit 212 calculates a first residual for the first pixel corresponding to the first group of pixels in the differential image DI and a second residual for the second pixel corresponding to the second group of pixels in the differential image DI, based on the differential image DI obtained by the difference between the information regarding each pixel in the generated image PI and the information regarding each pixel in the training image TI.

Then, in step 13 for the determination, the determination unit 213 determines that the training of the model is completed when a second predetermined condition applied to the second residual is a stricter condition than a first predetermined condition applied to the first residual, the second residual satisfies the second predetermined condition, and the first residual satisfies the first predetermined condition. Here, the stricter condition may include setting a threshold for the second residual to be smaller than a threshold used for the first residual. Alternatively, the stricter condition may include using the same threshold but correcting the second residual such that the residual is overestimated. Furthermore, the stricter condition may include correcting the first residual such that the residual is underestimated. Other steps and components are included in the descriptions of the first to third embodiments and the modified example which are described above.

According to the present embodiment, the training completion of the model is determined under the stricter condition, and thus the accuracy of the model can be improved.

### Fifth Embodiment

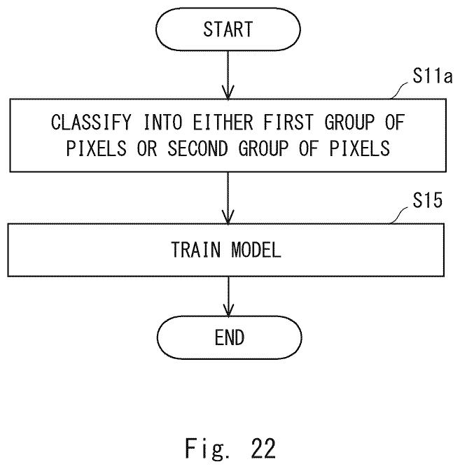

Next, a learning method according to a fifth embodiment will be described. FIG. 22 is a flowchart illustrating a learning method using the learning unit 210 in the information processing apparatus 201 according to the fifth embodiment. As illustrated in FIG. 22, the learning method of the present embodiment includes step S11a of classifying pixels into either a first group of pixels or a second group of pixels and step S15 of training a model.

In step S11a, the processing unit 270 classifies the plurality of pixels in the captured image CI into either a first group of pixels or a second group of pixels, based on a comparison of the plurality of captured images CI with respect to a substantially same region of the object 300. Here, the processing unit 270 defines the second group of pixels as pixels having smaller variation in information regarding the pixels among the plurality of captured images CI with respect to the substantially same region of the object 300 than the first group of pixels.

In step S15, the training unit 214 uses, as training data, the captured image CI of the object 300 and the image based on the design data D10 of the object 300, to train the rendering model M10 that outputs, based on the design data D10, the reference image RI to be compared with the captured image CI. In step S15, the training data may include the captured images CI including the first group of pixels and the captured images CI including the second group of pixels. Furthermore, the number of captured images CI including the first group of pixels may be larger than the number of captured images CI including the second group of pixels.

According to the present embodiment, it is possible to train more areas where the residual is likely to remain.

Although the embodiments of the present disclosure have been described above, the present disclosure includes appropriate modifications without impairing the object and advantages thereof and is not limited to the above-described embodiments. Further, combinations of the configurations of the first and second embodiments are also within the scope of the technical concept of the present disclosure. Furthermore, the following learning program that causes a computer to execute the learning method of the embodiments is also within the scope of the technical concept of the present disclosure.

### (Supplementary Note 1)

A learning program that causes a computer to execute steps of: calculating a residual by comparing a generated image output from a model in a training course with a training image including a captured image obtained by capturing an image of an object; and
determining that training of the model is completed when the residual satisfies a predetermined condition,
the step of calculating the residual including:
calculating the residual based on a differential image obtained by a difference between information regarding each pixel in the generated image and information regarding each pixel in the training image;
calculating a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and
calculating the residual of the differential image by performing arithmetic processing on the corrected evaluation value.

### (Supplementary Note 2)

The learning program according to Supplementary Note 1, in which, the learning program causes, in the step of calculating the residual, the computer to perform a larger weighting on the evaluation value of the second pixel than on the evaluation value of the first pixel.

### (Supplementary Note 3)

The learning program according to Supplementary Note 1, in which, the learning program causes, in the step of calculating the residual, the computer to calculate the residual of the differential image by performing arithmetic processing on at least one of an average value of the corrected evaluation values of the plurality of pixels and a maximum value of the corrected evaluation values of the plurality of pixels.

### (Supplementary Note 4)

The learning program according to Supplementary Note 1, in which, the learning program causes, in the step of calculating the residual, the computer to
acquire a statistical value indicating a degree of variation in information regarding a pixel among a plurality of captured images for a plurality of pixels of the captured images, based on a comparison of the plurality of captured images for a substantially same region of the object, and
calculate the weighting for the evaluation value of the differential image based on the acquired statistical value.

### (Supplementary Note 5)

The learning program according to Supplementary Note 1, in which, the learning program causes the computer to execute steps of: calculating a residual by comparing a generated image output from a model in a training course with a training image including a captured image obtained by capturing an image of an object;
determining that training of the model is completed when the residual satisfies a predetermined condition; and
classifying a plurality of pixels in the captured image into either a first group of pixels or a second group of pixels, based on a comparison of a plurality of captured images for a substantially same region of the object, and
the second group of pixels are pixels having smaller variation in information regarding the pixels among the plurality of captured images with respect to the substantially same region of the object than the first group of pixels,
the step of calculating the residual including:
calculating the residual based on a differential image obtained by a difference between information regarding each pixel in the generated image and information regarding each pixel in the training image;
calculating a corrected evaluation value, which is corrected by performing different weightings on an evaluation value of a first pixel corresponding to the first group of pixels in the differential image and an evaluation value of a second pixel corresponding to the second group of pixels in the differential image; and
calculating the residual of the differential image by performing arithmetic processing on the corrected evaluation value.

### (Supplementary Note 6)

The learning program according to Supplementary Note 1, in which, the learning program causes the computer to execute steps of: calculating a residual by comparing a generated image output from a model in a training course with a training image including a captured image obtained by capturing an image of an object;
determining that training of the model is completed when the residual satisfies a predetermined condition; and
classifying a plurality of pixels in the captured image into either a first group of pixels or a second group of pixels, based on a comparison of a plurality of captured images for a substantially same region of the object, and
the second group of pixels are pixels having smaller variation in information regarding the pixels among the plurality of captured images with respect to the substantially same region of the object than the first group of pixels,
the step of calculating the residual includes calculating a first residual for a first pixel corresponding to the first group of pixel in the differential image and a second residual for a second pixel corresponding to the second group of pixels in the differential image, based on a differential image obtained by a difference between information regarding each pixel in the generated image and information regarding each pixel in the training image, and
the step of determining that training of the model is completed when the residual satisfies a predetermined condition includes determining that the training of the model is completed when a second predetermined condition applied to the second residual is a stricter condition than a first predetermined condition applied to the first residual, the second residual satisfies the second predetermined condition, and the first residual satisfies the first predetermined condition.

### (Supplementary Note 7)

The learning program according to Supplementary Note 1, in which, the learning program causes the computer to execute steps of: classifying a plurality of pixels in the captured image into either a first group of pixels or a second group of pixels, based on a comparison of a plurality of captured images for a substantially same region of an object; and
using, as training data, the captured image of the object and an image based on design data of the object, and training a model that outputs, based on the design data, a reference image to be compared with the captured image,
the second group of pixels are pixels having smaller variation in information regarding the pixels among the plurality of captured images with respect to the substantially same region of the object than the first group of pixels, and
in the step of training the model, the training data includes the captured image including the first group of pixels and the captured image including the second group of pixels, and the number of captured images including the first group of pixels is larger than the number of captured images including the second group of pixels.

Furthermore, the above-described learning program includes a set of instructions (or software codes) that, when read into a computer, causes the computer to perform one or more of the functions described in the embodiments. The learning program may be stored in a non-transitory computer-readable medium or in a physical storage medium. By way of example rather than limitation, a computer-readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The learning program may be transmitted on a transitory computer-readable medium or a communication medium. By way of example rather than limitation, the transitory computer-readable medium or the communication medium may include electrical, optical, acoustic, or other forms of propagating signals.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to fifth embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information processing apparatus comprising:
a learning unit configured to train a model;
a captured image acquisition unit configured to acquire a captured image obtained by capturing an image of an object;
a reference image generation unit configured to generate a reference image based on design data of the object and the model; and
an evaluation unit configured to evaluate the object based on a comparison between the reference image and the captured image,
the learning unit including:
a residual calculation unit configured to calculate a residual by comparing a generated image output from the model in a training course with a training image including the captured image; and
a determination unit configured to determine that training of the model is completed when the residual satisfies a predetermined condition,
the residual calculation unit being configured to:
calculate the residual based on a differential image obtained by a difference between information regarding each pixel in the generated image and information regarding each pixel in the training image;
calculate a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and
calculate the residual of the differential image by performing arithmetic processing on the corrected evaluation value.

2. The information processing apparatus according to claim 1, wherein the residual calculation unit performs a larger weighting on the evaluation value of the second pixel than on the evaluation value of the first pixel.

3. The information processing apparatus according to claim 1, wherein the residual calculation unit calculates the residual of the differential image by performing arithmetic processing on at least one of an average value of the corrected evaluation values of the plurality of pixels and a maximum value of the corrected evaluation values of the plurality of pixels.

4. The information processing apparatus according to claim 1, wherein the residual calculation unit is configured to:
acquire a statistical value indicating a degree of variation in information regarding a pixel among a plurality of captured images for a plurality of pixels of the captured images, based on a comparison of the plurality of captured images for a substantially same region of the object; and
calculate a weighting for the evaluation value of the differential image based on the acquired statistical value.

5. The information processing apparatus according to claim 1,
wherein the residual calculation unit is configured to classify the pixels into three or more luminance levels and to perform weighting on evaluation values corresponding to the respective luminance levels.

6. An information processing method comprising steps of:
training a model;
acquiring a captured image obtained by capturing an image of an object;
generating a reference image based on design data of the object and the model; and
evaluating the object based on a comparison between the reference image and the captured image,
the step of training the model including steps of:
calculating a residual by comparing a generated image output from the model in a training course with a training image including the captured image; and
determining that training of the model is completed when the residual satisfies a predetermined condition,
the step of calculating the residual including:
calculating the residual based on a differential image obtained by a difference between information regarding each pixel in the generated image and information regarding each pixel in the training image;
calculating a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and
calculating the residual of the differential image by performing arithmetic processing on the corrected evaluation value.

7. The information processing method according to claim 6, wherein the step of calculating the residual includes performing a larger weighting on the evaluation value of the second pixel than on the evaluation value of the first pixel.

8. The information processing method according to claim 6, wherein the step of calculating the residual includes calculating the residual of the differential image by performing arithmetic processing on at least one of an average value of the corrected evaluation values of the plurality of pixels and a maximum value of the corrected evaluation values of the plurality of pixels.

9. The information processing method according to claim 6, wherein the step of calculating the residual includes:
acquiring a statistical value indicating a degree of variation in information regarding a pixel among a plurality of captured images for a plurality of pixels of the captured images, based on a comparison of the plurality of captured images for a substantially same region of the object; and
calculating a weighting for the evaluation value of the differential image based on the acquired statistical value.

10. The information processing method according to claim 6,
wherein the step of calculating the residual includes classifying the pixels into three or more luminance levels and performing weighting on evaluation values corresponding to the respective luminance levels.

11. A learning method comprising steps of:
calculating a residual by comparing a generated image output from a model in a training course with a training image including a captured image obtained by capturing an image of an object; and
determining that training of the model is completed when the residual satisfies a predetermined condition,
the step of calculating the residual including:
calculating the residual based on a differential image obtained by a difference between information regarding each pixel in the generated image and information regarding each pixel in the training image;
calculating a corrected evaluation value, which is corrected by performing different weightings on an evaluation value of a first pixel in the differential image corresponding to a pixel whose pixel information based on at least one of the information regarding the pixel in the generated image and the information regarding the pixel in the training image indicates first luminance, and an evaluation value of a second pixel in the differential image corresponding to a pixel whose pixel information based on at least one of the information regarding the pixel in the generated image and the information regarding the pixel in the training image indicates second luminance lower than the first luminance; and
calculating the residual of the differential image by performing arithmetic processing on the corrected evaluation value.

12. The learning method according to claim 11, wherein the step of calculating the residual includes performing a larger weighting on the evaluation value of the second pixel than on the evaluation value of the first pixel.

13. The learning method according to claim 11, wherein the step of calculating the residual includes calculating the residual of the differential image by performing arithmetic processing on at least one of an average value of the corrected evaluation values of the plurality of pixels and a maximum value of the corrected evaluation values of the plurality of pixels.

14. The learning method according to claim 11, wherein the step of calculating the residual includes:
acquiring a statistical value indicating a degree of variation in information regarding a pixel among a plurality of captured images for a plurality of pixels of the captured images, based on a comparison of the plurality of captured images for a substantially same region of the object, and
calculating a weighting for the evaluation value of the differential image based on the acquired statistical value.

15. The learning method according to claim 11,
wherein the step of calculating the residual includes classifying the pixels into three or more luminance levels and performing weighting on evaluation values corresponding to the respective luminance levels.

16. A learning method comprising steps of:
calculating a residual by comparing a generated image output from a model in a training course with a training image including a captured image obtained by capturing an image of an object;
determining that training of the model is completed when the residual satisfies a predetermined condition; and
classifying a plurality of pixels in the captured image into either a first group of pixels or a second group of pixels, based on a comparison of a plurality of captured images for a substantially same region of the object,
wherein the second group of pixels are pixels having smaller variation in information regarding the pixels among the plurality of captured images with respect to the substantially same region of the object than the first group of pixels, and
wherein the step of calculating the residual includes:
calculating the residual based on a differential image obtained by a difference between information regarding each pixel in the generated image and information regarding each pixel in the training image;
calculating a corrected evaluation value, which is corrected by performing different weightings on an evaluation value of a first pixel corresponding to the first group of pixels in the differential image and an evaluation value of a second pixel corresponding to the second group of pixels in the differential image; and
calculating the residual of the differential image by performing arithmetic processing on the corrected evaluation value.

17. A learning method comprising steps of:
calculating a residual by comparing a generated image output from a model in a training course with a training image including a captured image obtained by capturing an image of an object;
determining that training of the model is completed when the residual satisfies a predetermined condition; and
classifying a plurality of pixels in the captured image into either a first group of pixels or a second group of pixels, based on a comparison of a plurality of captured images for a substantially same region of the object,
wherein the second group of pixels are pixels having smaller variation in information regarding the pixels among the plurality of captured images with respect to the substantially same region of the object than the first group of pixels,
wherein the step of calculating the residual includes calculating a first residual for a first pixel corresponding to the first group of pixels in a differential image and a second residual for a second pixel corresponding to the second group of pixels in the differential image, based on the differential image obtained by a difference between information regarding each pixel in the generated image and information regarding each pixel in the training image, and
wherein the step of determining that training of the model is completed when the residual satisfies the predetermined condition includes determining that the training of the model is completed when a second predetermined condition applied to the second residual is a stricter condition than a first predetermined condition applied to the first residual, the second residual satisfies the second predetermined condition, and the first residual satisfies the first predetermined condition.

18. A learning method comprising steps of:
classifying a plurality of pixels in a captured image into either a first group of pixels or a second group of pixels, based on a comparison of a plurality of captured images for a substantially same region of an object; and
using, as training data, the captured image of the object and an image based on design data of the object, and training a model that outputs, based on the design data, a reference image to be compared with the captured image,
wherein the second group of pixels are pixels having smaller variation in information regarding the pixels among the plurality of captured images with respect to the substantially same region of the object than the first group of pixels, and
wherein in the step of training the model, the training data includes the captured image including the first group of pixels and the captured image including the second group of pixels, and the number of captured images including the first group of pixels is larger than the number of captured images including the second group of pixels.

19. The learning method according to claim 16,
wherein the pixels are classified into three or more groups, and
wherein weighting is performed with respect to the respective groups.

20. The learning method according to claim 17,
wherein the pixels are classified into three or more groups, and
wherein calculating residuals and applying conditions is performed with respect to the respective groups.

21. The learning method according to claim 18,
wherein the pixels are classified into three or more groups, and
wherein the number of captured images is determined with respect to the respective groups.
